(19) United States
(12) Patent Application Publication
(10) Pub. No.: US 2015/0186861 A1
(43) Pub. Date: Jul. 2, 2015

(54) Lockable POS Device, Method for Distributing Lockable POS Devices, and Method for Locking a Lockable POS Device

(71) Applicant: XTT LLC, Pompano Beach, FL (US)

(72) Inventor: Terry L. Glatt, Pompano Beach, FL (US)

(21) Appl. No.: 14/540,032

(22) Filed: Nov. 12, 2014

Related U.S. Application Data
(60) Provisional application No. 61/903,352, filed on Nov. 12, 2013.

(51) Int. Cl. G06Q 20/20; G06Q 20/38

(52) U.S. Cl. CPC G06Q 20/206; G06Q 20/382

(57) ABSTRACT

A point of sale (POS) device that includes electronic transactions can be locked so that a merchant must use the device and credit card processing with a particular merchant services provider/independent sales organization (MSP/ISO) and meet predefined business conditions. By locking the POS device to the MSP/ISO, the MSP/ISO can discount the price of the POS to the merchant with the comfort that the MSP/ISO will recover the cost through the fees collected from subsequent charges or business volume implemented in a service agreement. To lock the point of sale device, an encrypted key can be stored in the POS device. To remain active, the POS device periodically can confirm that the POS device remains authorized and associated with the MSP/ISO.

### CROSS-REFERENCE TO RELATED APPLICATIONS

This application claims the benefit of U.S. Provisional Application No. 61/903,352, filed Nov. 12, 2013, which is hereby incorporated by reference.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to point of sale (POS) devices, and in particular to the provisioning of point of sale devices with a particular payment processor or payments processing sales organization.

2. Description of the Related Art

Dealer distribution of POS devices is limited by the traditional sales and distribution model. The POS devices are sold to the end user by dealers and sales representatives who sell a value proposition based on the equipment and software itself.

To begin, a few terms and definitions used in payment processing and this application are provided.

An acquiring bank (or acquirer) is a bank or financial institution that processes credit or debit card payments on behalf of a merchant. The term acquirer indicates that the bank accepts or acquires credit card payments from the card-issuing banks within an association. The best-known (credit) card associations are Visa, MasterCard, Discover, American Express, Diners Club, Japan Credit Bureau and China UnionPay.

An acquiring bank enters into a contract with a merchant and offers the merchant a merchant account. The arrangement provides the merchant with a line of credit. Under the agreement, the acquiring bank exchanges funds with issuing banks on behalf of the merchant, and pays the merchant for its daily payment-card activity's net balance—that is, gross sales minus reversals, interchange fees, and acquirer fees.

Independent Sales Organization (aka ISO) is a term used within the payment industry to identify an individual or organization that is not an Association (Visa & MasterCard) Member. However, ISO's have bank card relationships with an Association Member (banks) who participate in issuing or acquiring functions.

ISO's can also be referred to as Member Service Providers (MSP), this terminology most commonly differs between the card associations. MasterCard defines MSP as, “A non-member that is registered by the Corporation [MasterCard] as an MSP to provide Program Services to a member, or any member that is required to register, in the Corporation's sole discretion, and has been registered as an MSP to provide Third Party Processor Program Services to another member. Each acquirer must register each ISO/MSP with the appropriate Association. So, ISOs and MSPs are not banks and the actual handling of the merchants' money is done by the processing bank that has contracted with the ISO. Each ISO/MSP must be sponsored by such a processing bank, member of Visa and/or MasterCard, in order to be registered by either Credit Card Association. Typically, processing banks are members of both Associations and the registration process for each Association is done simultaneously. An ISO/MSP can be sponsored by multiple member banks. Agents are just that, they are agents or sales people (known as Merchant Level Salespeople [MLS]) and are used by almost every ISO/MSP to bring in new merchants. Agents are only allowed to advertise as representatives as the company for which they are an agent.

POS devices can include registers, computer terminals, credit card terminals, and other hardware devices that are programmed to allow merchants to accept electronic payments using credit cards and other payment forms. Devices and systems that employ software solutions for accepting electronic payments, including devices using applications, middleware, and operating systems sold under the trade names OPOS, JAVAPOS, WINDOWS®, IOS, ANDROID, LINUX®, are also considered POS devices.

An alternative to dealer distribution is to have Member Services Providers (MSP) and Independent Sales Organizations (ISO) offer POS devices to their merchants. The MSP/ISOs are already “on the street” selling into the exact types of businesses that would benefit from POS.

The problem is the transaction model and how each party realizes payment and profit. MSP/ISOs are “precious” about their merchants and very sensitive about proper treatment of them. Often, a POS dealer's interests are not aligned with the MSP/ISO's interests and these conflicts can create problems.

A solution would be for MSP/ISOs to develop, buy, or otherwise their own POS product line. However, the investment required is often much too large for an MSP/ISO to justify building or buying their own POS product line. Alternatively, an MSP/ISO could resell POS software and systems. However, the pass-along cost to the merchant is still significant and a “tough sell.”

If the MSP/ISO could offer a subsidized model where their offering would have a much more palatable payment scheme for the merchant, there could be a significant boon to POS sales. However, subsidizing the POS equipment is risky in that the MSP/ISO cannot be assured that the merchant will not go to another MSP/ISO and use the POS system with another MSP/ISO, circumventing their ability to realize payback for their subsidized investment.

### BRIEF SUMMARY OF THE INVENTION

The invention encompasses a system and method for locking a POS device to a particular MSP/ISO or payment processor.

An object of the invention is to authorize the functionality and payment module of a POS device to be based on a combination of information including a merchant account identifier (MID), a business identifier (BID), and a hardware identifier (HID).

A Merchant account Identifier (MID) is defined as a unique value in a database that is related to one, and only one merchant account of a merchant. Typically, the MID is an alphanumeric value assigned by a payment processor.

A Business Identifier (BID) is defined as a unique value in a database that is related to one, and only one, business of a merchant. Typically, the BID is an alphanumeric value. The BID can be a federal tax identification number, phone number, or other value unique to the business. The BID can be a string derived from the federal tax identification number, phone number, or other value unique to the business.

A Hardware Identifier (HID) is defined as a unique value in a database that identifies the hardware of an alphanumeric value that uniquely identifies the POS device. Typically, the HID identifies the hardware running the payment software. The HID of a POS device can be a

MAC address of a network interface controller or other string that identifies the hardware.

An object of the invention is to enable MSP/ISOs to sell POS systems using a subsidized model, much like cellular telephones. That is, the MSP/ISO pays for at least a portion of the cost of the POS device in exchange for the merchant's promise to use the POS device with the MSP/ISO. The MSP/ISO recovers the cost of the POS device over the lifetime of its use by the merchant by charging the merchant fees. The lock down ensures that the POS system only can be used with authorization from the selling MSP/ISO., the lock down enables an entirely new POS distribution model using MSP/ISOs.

### Software Lock Down

The software MSP/ISO Lock Down implements a protocol whereby the POS software is configured to generate an empirical security key. The security key can be generated from the information programmed into the payment module. More particularly, the security key can be generated from at least one of a MID (e.g. account number), BID, and a device identifier (e.g. an HID). Most preferably, the security key is generated from all three of the MID, the BID, and the HID. At configurable intervals, the software checks a web site service and if there is a match between the empirical security key (i.e. the information that the payment module is currently programmed with) and a control security key, the device is enabled, if not, credit card transactions, or the entire POS device is locked down. The enabled system keys are encrypted on the web site by either the point-of-sale (POS) device company or the MSP/ISO as the units ship. The key is generated by the provider's server by inputting a BID, a MID, and a HID into encryption software; the encryption software outputs the software key. The software key is entered into the software by the user, which has the algorithm embedded for encrypting and decrypting the software key. This means when an MSP/ISO receives POS equipment from the manufacturer, the units they receive can be locked down for them so the merchant cannot use the software with another MSP/ISO.

When a security key is based on the MID, the processor will only accept payment transactions from the merchant that utilize the security key. If the merchant submits a transaction to the processor with a secruity key based on a different MID (i.e. a different merchant account), the processor will not process the transaction.

When a security key is based on the BID, the processor only will accept payment transactions from the merchant that utilize the secruity key. If the processor receives a transaction with a security key based on a different BID (i.e. the merchants changes its EIN), then the processor will not process the transaction.

When a security key is based on the HID, the processor only will accept payment transactions from the merchant that utilize the secruity key. If the processor receives a transaction with a security key based on a different HID (i.e. a different POS device is used by ther merchant), then the processor will not process the transaction.

Security keys based on combinations of BID, MID, and HID combine the previously listed requirements. For example, when a security key is generated from the BID, MID, and HID, the processor will not process a transaction if any one of the BID, MID, and HID are changed.

When the security key is generated from a given piece of information or multiple pieces of information, changes in the device settings or the payment module can be controlled when that piece or pieces of information are changed. If the device authorization is to be controlled by monitoring solely a list of authorized POS devices, then the security key can be generated from the HID only. However, if the MSP/ISO or processor wants to confirm that the device is being used with a particular combination of MID, BID, and HID, then the security key will be generated from all three.

Alternatively, when the merchant receives the POS device, the MSP/ISO has already locked the POS device for them.

In accordance with the objects of the invention, a lockable POS device is provided. The lockable POS device includes a software lock for preventing the device from operating. The software lock is unlocked with an electronic key. The electronic key is a mathematical result derived from a MID (e.g. an account number of the merchant) or other unique identifier of the merchant to an MSP/ISO or processor. Alternatively or in addition to, the electronic key can also be a mathematical result derived from a hardware specific identifier. A MAC address of the network interface card (NIC) in the POS device is an example of a HID.

In accordance with the objects of the invention, a method for disabling a POS device includes the following steps. The first step involves entering a first MID (i.e. the information the payment module is supposed to be or is authorized to be programmed with). When the MID-derived empirical security key and the control key match, the device is authorized or the processing module is authorized to processing payments in the POS device. When the MID-derived empirical security key and the control security key do not match, as when a different MID is entered, the device is deauthorized or the processing module is deauthorized to process payments. The security keys can be checked periodically: for example, at startup, after a given amount of time, after a given number of transactions, or upon some other software or configuration event.

In accordance with a further object of the invention, a method for disabling a POS device is provided. The first step of the method involves entering or detecting a first HID in the POS device. The next step involves preventing the POS device from operating when a second HID is found on the device. The method can include generating an electronic key from the first HID. The method can include decrypting the first HID from the electronic key and performing the preventing step when the first HID does not match the second (i.e. the current) HID. T his condition may indicate an unauthorized change in hardware.

In accordance with the objects of the invention, a method for disabling a POS device includes the following steps. The first step involves entering a first BID (i.e. the information the payment module is supposed to be or is authorized to be programmed with). When the BID-derived empirical security key and the control key match, the device is authorized or the processing module is authorized to processing payments in the POS device. When the BID-derived empirical security key and the control security key do not match, as when a different BID is entered, the device is deauthorized or the processing module is deauthorized to process payments. The security keys can be checked periodically: for example, at startup, after a given amount of time, after a given number of transactions, or upon some other software or configuration event.

The POS device can be disabled in two stages. The POS device is placed into a temporary mode for a period of time after detecting when the first MID, HID, or BID does not match the second. The second stage is entered after the period of time expires and a matching authorized identifier is not provided. The POS device is placed into a permanently disabled mode when the first identifier does not match said second identifier after the period of time expires.

### Business Model

The invention actually introduces a unique business model for selling POS equipment. Offering the MSP/ISO lock down enables a subsidy model for MSP/ISOs to purchase POS systems and software to resell based on an acceptable payback model. For example, the MSP/ISO might pay two-thousand dollars ($2,000) for a system, but could provide the system to a merchant for a discount or no charge based on the merchant's commitment to a profitable merchant processing contract for two (2) years. This contract could enable a payback point after which the relationship is profitable for the MSP/ISO. This business model is additionally enabled by the fact that POS systems are “sticky” where by merchants are inclined to stay with the system since it manages their clients, staff, products, services, etc. In other words, the POS system becomes an integral part of their business and abandoning it is a MUCH more difficult consideration than switching merchant processing based solely on a traditional credit card terminal for a small savings.

Scenarios like these have been done before, but only with a one-to-many, provider-to-users relationship, e.g. MICROSOFT® and MICROSOFT OFFICE® users or cable-TV provider to subscribers. In this invention, the system will enable a many-to-many relationship whereby many MSP/ISOs can sell the POS equipment to many users, yet the systems would be configurably locked down MSP/ISO by MSP/ISO, merchant by merchant.

A further object of the invention is to provide MSP/ISOs and processors with the ability to deactivate a POS device remotely, particularly when suspicious transactions are detected by the MSP/ISOs or processors. MSP/ISOs and processors regularly monitor the transactions performed by merchants and by particular POS devices. When irregular or suspicious transactions are detected by the MSP/ISO or processor, the MSP/ISO or processor can revoke a security key. The POS will not be able to authenticate and the entire device or the payment module will be disabled. The merchant can contact the MSP/ISO or processor to confirm the suspicious transactions and to reauthorize the security key of the POS device.

Other features of the invention are set forth in the appended claims.

Although the invention is illustrated and described herein as embodied in a system and method for locking a point of sale device to a single MSP/ISO or processor, the invention is not limited to the details shown because various modifications and structural changes may be made without departing from the invention and the equivalents of the claims. However, the construction and method of operation of the invention together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a schematic view of a POS device.

FIG. 2 is a schematic view of a computer network including a POS device and a payment processor.

FIG. 3 is a schematic view of a computer network that includes a POS device connected to a processer server.

### DETAILED DESCRIPTION OF THE INVENTION

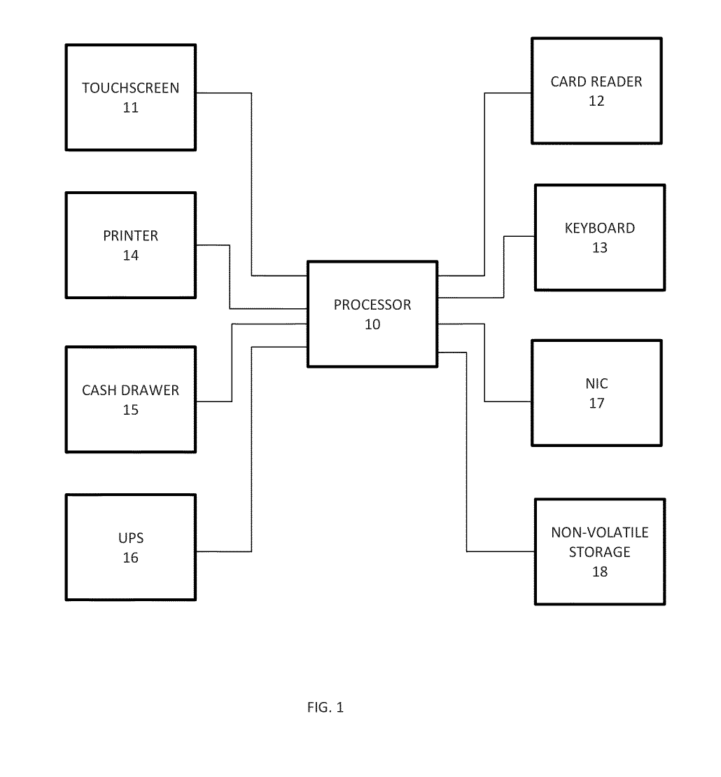

FIG. 1 shows a preferred embodiment of a POS device. The POS device includes a computer processor 10. A touchscreen 11 is connected to the processor 10. The touchscreen 11 displays data sent from the processor 10. Users can input data with the touchscreen 11. The touchscreen 11 transmits data to the processor 10. A card reader 12 is connected to the processor 10. The card reader 12 reads credit-card data from a credit card and transmits the credit-card to the processor 10. In one embodiment, the card reader 12 is a magnetic-strip reader. In a second embodiment, the card reader 12 is a smart-card reader. A keyboard 13 is connected to the processor 10. Users can import data with the keyboard 13. The keyboard 13 transmits the data to the processor 10. A printer 14 is connected to the processor. The processor 10 outputs data to be printed to the printer 14. The printer 14 prints receipts of credit-card purchases and refunds. A cash drawer 15 is connected to the processor 10. The cash drawer 15 stores cash from purchases. The processor 10 locks and unlocks the cash drawer 15 before and during cash purchases and refunds. An uninterrupted power supply (UPS) 16 is connected to the processor 10. The UPS 16 prevents an interruption to a primary power supply from stopping the POS device from operating. A network interface card (NIC) 17 is connected to the processor 10. The NIC 17 has a unique hardware identifier (HID). In the preferred embodiment, the HID is the MAC address of the NIC 17. The NIC can form a wired or wireless connection to a network to which the payment processor is attached. Data that is to be transmitted and received between the processor 10 and the payment processor passes through the NIC 17. Non-volatile storage 18 is connected to the processor 10. The non-volatile storage 18 includes a database. A preferred form of the database is a SQL database. The processor 10 reads data from and writes data to the database on the non-volatile storage 18.

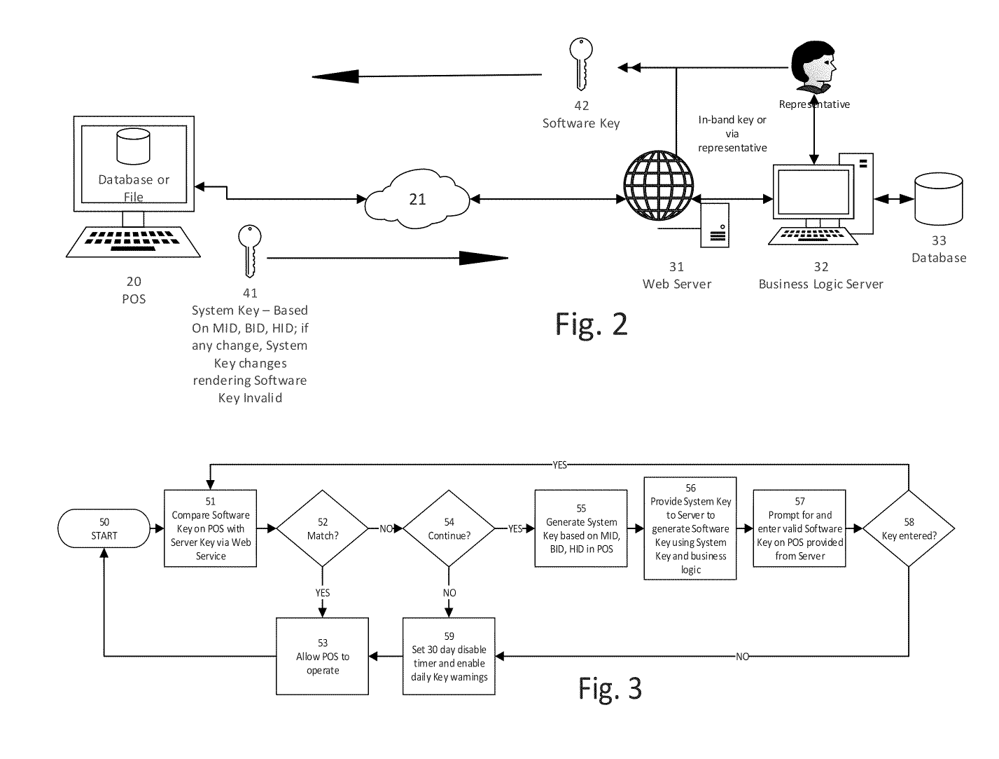

FIG. 2 shows a computer network. The computer network includes a POS device 20. The POS device 20 is connected to a TCP/IP network 21, preferably the Internet. A payment processor 30 is also connected to the network 21. Data is sent between the POS device 20 and the payment processor 30 over the network 21.

The payment processor 30 includes a number of connected computer servers. A web server 31 is connected to the network 31. The web server 31 receives data from the POS device 20 and transmits data to the POS device 20. A business logic server 32, which is also known as an application server, implements the business logic used by the payment processor. The business logic server 32 is connected to the web server 31. A database 33 is connected to the business logic server 32 and stores data related to payment transactions and POS devices.

When a merchant forms a relationship with an MSP/ISO and commits to processing electronic payments with the MSP/ISO, the MSP/ISO or a representative of the MSP/ISO provides the merchant with a merchant identifier (MID). In addition, the MSP/ISO records a business identifier of the merchant, for example, the Federal Employer Identification Number (FEIN) of the merchant. In addition, the MSP/ISO records a hardware identifier (HID) of the POS device 20, preferably a MAC Address of a NIC in the POS device 20.

The business logic server 32 generates a software key. In a preferred embodiment, the software key is generated in a one-way hash from the MID, BID, and HID. An example of a preferred one-way has is bitwise interweave encryption.

The POS device 20 generates a system key using the same algorithm that the business logic server 32 uses to generate the software key. The POS device 20 uses the MID, BID, and HID stored within the POS device to generate the system key.

FIG. 3 shows a flow chart of how the POS device 20 is authenticated periodically. In one preferred embodiment, the POS device 20 is authenticated at each start up. In another preferred embodiment, the POS device 20 is authenticated daily. Step 50 is the start of the authentication. In step 51, the POS device 20 transmits the system key 41 to the business logic server 32. The business logic server 32 compares the system key to the software key stored in the database 33. At step 52, if the system key 41 matches the software key 42, the payment processor will continue to process payments transmitted from the POS device 20 as shown in step 53. If the system key 41 does not match the software key 42, the POS device 20 prompts its user to continue. If the user choses to continue, in step 55, the POS device generates a replacement system key 41 based on the MID, BID, and HID stored in the POS device 20. In step 56, the POS device 20 transmits the system key 41 to the processor server 30. The business logic server generates a software key using the system key and business logic. At step 57, the POS device 20 prompts the user to enter a valid software key on the POS that is provided from the server 30. In step 58, if the software key 42 is entered in the POS device 20, then the method returns to step 51. If no key is entered after step 57, a timer is activated in the POS device 20. The timer will deactivate the POS device 20 if the POS device 20 is not authenticated before the timer expires. A preferred time for the timer is thirty days.

While the embodiments, figures, and examples show the preferred embodiment of the invention, the scope of the claims should not be limited to the embodiments, figures, and examples.

What is claimed is:

1. A lockable point of sale device for processing electronic transactions with a given merchant services provider/independent sales organization (MSP/ISO) or processor, comprising:
computer memory;
a digital security key stored in said computer memory; and
a POS device being connected to said computer memory, said POS device being configured to exchange the security key with a computer and determine an authorization from said computer when the security key is active with an MSP/ISO, said POS device being further configured to deactivate transaction authorization on said POS device when said authorization is not determined.

2. The locked POS device according to claim 1, wherein said POS device contacts the computer periodically.

3. The locked POS device according to claim 1, wherein said POS device prevents all payment transactions when said authorization is not determined.

4. The locked POS device according to claim 1, wherein said digital security key is encrypted.

5. The locked POS device according to claim 1, wherein said system key is saved in said memory by a POS manufacturer.

6. The locked POS device according to claim 1, wherein said system key is saved in said memory by an MSP/ISO before shipping the locked POS device.

7. A method of providing a locked POS device for less than cost, which comprises:
acquiring a POS device for a cost to an MSP/ISO;
locking said POS device to said MSP/ISO;
providing said POS device to a merchant for a price less than the cost to said MSP/ISO; and
requiring said merchant to process electronic transactions using said POS only with said MSP/ISO.

8. The method according to claim 7, wherein said price is free.

9. The method according to claim 7, wherein said requiring step is for a given amount of time from a time of sale of the POS device to the merchant.

10. The method according to claim 7, which further comprises storing a security key in said POS device.

11. The method according to claim 7, wherein said security key is encrypted.

12. The method according to claim 7, which further comprises:
sending an activation request from the POS device to the MSP/ISO;
sending an authorization confirmation from said MSP/ISO to said process when said POS device remains associated with the MSP/ISO; and
enabling said POS device to initiate an electronic transaction after confirming said authorization from said MSP/ISO.

13. A lockable POS device, comprising a software lock for disabling a transaction function, said software lock being unlockable by an electronic key, said electronic key being a mathematical result derived from at least one of a merchant account identifier, a unique identifier of a business, and a unique identifier of hardware in the POS device.

14. The lockable POS device according to claim 13, wherein said electronic key is derived from said hardware specific identifier.

15. The lockable POS device according to claim 14, wherein said hardware specific identifier is a MAC address.

16. The lockable POS device according to claim 13, wherein said electronic key is derived from said business specific identifier 17. The lockable POS device according to claim 13, wherein said electronic key is derived from said merchant account identifier and said hardware specific identifier.

18. The lockable POS device according to claim 13, wherein said electronic key is derived from said merchant account identifier and said business specific identifier.

19. The lockable POS device according to claim 13, wherein said electronic key is derived from said business specific identifier and said hardware specific identifier.

20. The lockable POS device according to claim 13, wherein said electronic key is derived from said merchant account identifier, said hardware specific identifier, and said business specific identifier.

21. A method for disabling a POS device, which comprises:
entering at least one of a merchant account identifier, a business identifier, and a hardware identifier for processing a transaction in the POS device;
generating an empirical security key from said at least one of a merchant account identifier, a business identifier, and a hardware identifier; and
preventing the POS device from processing a transaction when said security key does not match a control security key merchant account identifier.

22. The method according to claim 21, which further comprises disabling a transaction processing module of the POS device for a period of time after detecting when said empirical security key hardware identifier does not match said control security key hardware identifier.

23. The method according to claim 22, which further comprises disabling the POS device when said empirical hardware identifier security key does not match said control security key hardware identifier after said period of time expires.

24. The method according to claim 21, which further comprises:
detecting a suspicious payment transaction sent by the POS device; and
revoking the control security key merchant account identifier.

25. A lockable POS device for a merchant, comprising:
at least one of a merchant identification for identification a merchant account assigned to the merchant, a business identification assigned to the merchant, and a hardware identification assigned to the POS device;
a computer configured to execute a payment module for processing a payment; said computer being further configured to execute a security module; said security module generating a security key from said at least one of a merchant identification, said business identification, and said hardware identification;
a network interface controller being connected to said computer and configured to check the security key on an authentication server, said network interface controller being further configured to receive device authorization from the authentication server;
said computer activating said payment module when said computer receives the payment module authorization.

26. The device according to claim 25, wherein said security module generates the security key from said merchant identification, said business identification, and said hardware identification.

27. The device according to claim 25, wherein said security module deactivates said device when the authorization is not received.

28. The device according to claim 25, wherein said security module deactivates said device when a predefined business condition is not met.
